(19) United States
(12) Patent Application Publication
(10) Pub. No.: US 2012/0109834 A1
(43) Pub. Date: May 3, 2012

(54) AUTOMATED BUSINESS AND INDIVIDUAL RISK MANAGEMENT AND VALIDATION PROCESS

(75) Inventors: Michele Bongiovanni, Hillsborough, NJ (US); Gabriel Pauliuc, Hillsborough, NJ (US); Purna Surya Kumar Mangipudi, Whitehall, PA (US); Matt Matulewicz, Easton, PA (US); Yashaswinee Phatak, Whitehall, PA (US)

(73) Assignee: The Dun & Bradstreet Corporation, Short Hills, NJ (US)

(21) Appl. No.: 13/189,220

(22) Filed: Jul. 22, 2011

Related U.S. Application Data
(60) Provisional application No. 61/367,205, filed on Jul. 23, 2010.

(51) Int. Cl. G06Q 99/00

(52) U.S. Cl. 705/317

(57) ABSTRACT

The system includes a unique automated and reusable validation process in support of the issuance of the registration seal. This includes the following: (1) individual identity validation; (2) individual/business association validation; and (3) business status validation. These services will be utilized to provide validation in real-time during the product ordering process, as well as the ongoing user and business status validations. In addition, a set of pre-established business rules are used to provide: (a) when the rules are satisfied, utilization of the registration seal is permitted, or (b) when the rules have not been met, the registration seal is revoked.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present disclosure generally pertains to a method and system for automating and validating businesses and individuals associated with those businesses by validating: (1) that the individual is who they say they are with a degree of certainty, (2) that the individual is associated with the business, and (3) that the business is a valid business and risk free with a degree of certainty. The present invention powers a registration seal or certification indicating that the business entity has been registered or listed with a trusted source, and a business and/or principal risk management system (e.g., enterprise risk broker) which periodically determines whether pre-defined business rules have been satisfied. If the business rules have not been met, then the registration seal or certification is revoked. In addition, the invention powers customer driven data updates and maintenance within an organization from an individual associated with a business, an up-front assessment prior to the procurement of a product, and a central call service or investigative decisioning tool used for either product or data decisioning.

2. Description of the Related Art

Risk management has become increasingly integral part of today's organizations. An integrated approach to risk management is crucial for enabling organizations to consolidate exposures, measure and monitor risk across all lines of business.

Currently there are limited verification and validation processes that are defined for business and individual entity verification. Existing validation processes are manual processes with limited verification and validation functionality, time consuming, resource intensive, costly and not in real-time. Also, current process does not support all kind of verifications such as business, individual, individual to business association, etc.

The present disclosure provides an integrated and flexible solution to identify, assess, quantify, monitor, and manage risk associated with business and/or individuals associated with a business in an automated manner. In addition, the present disclosure utilizes web-site registration seals to create and instill a trusted digital relationship between the data provider, its customers and their clients. The seals impart confidence and credibility with these clients and help differentiate the customer from their competitors. More particularly, they legitimize the company in a business environment that demands increased scrutiny by the consumer. A key advantage of the present disclosure is the integration of the application of a seal together with a risk management associated with a business and/or principals of that business in an automated manner, wherein the registered seal can be either issued or revoked depending upon a unique set of business rules, -as well as the infrastructure basis for decisioning via either a Web application program interface (API) or an investigative front-end tool.

The following are the advantages of automated validation of the present disclosure's enterprise risk broker (ERB) over the conventional methodologies.
1. ERB performs real time and automated business and individual verification.
2. ERB performs risk assessment based on rich trusted data sources such as Dun & Bradstreet (D&B), D&B's partners, public records and various Government Control Lists, etc. This provides a sense of credibility in the assessment on the data derived from the world's leading source of information.
3. Solution provides enterprise wide view and transparency into risk exposure. It provides flexibility in changing the business rules easily based on any changes in organizational strategy.

4. Reduce Validation Process Cost and Latency which will alleviate the need for costly and manual investigation.

The present disclosure also provides many additional advantages, which shall become apparent as described below.

### SUMMARY OF THE INVENTION

The system includes a unique automated and reusable validation process in support of the issuance of the registration seal, the updating of business data via a customer either directly or via a call center or investigation function. This includes the following: (1) individual identity validation; (2) individual/business association validation; and (3) business status validation. These services will be utilized to provide validation in real-time during the product ordering process, as well as the ongoing user and business status validations. In addition, the present disclosure provides a set of pre-established business rules that: (a) when the rules are satisfied, utilization of the registration seal is permitted, or (b) when the rules have not been met, the registration seal is revoked or the data update is rejected.

There is provided a method that includes:
receiving by way of an electronic communication, with reference to a first entity, rules for validating a business and rules for validating a person;
storing to a rules database by way of an electronic communication, the rules for validating a business and the rules for validating a person;
receiving by way of an electronic communication, a request to validate, for the first entity, a subject business and a subject person;
accessing the rules database by way of an electronic communication, to obtain the rules for validating a business and the rules for validating a person;
validating the subject business in accordance with the rules for validating a business, based on information in a business information database;
validating the subject person in accordance with the rules for validating a person, based on information in an individual information database; and
outputting by way of an electronic communication, a report that indicates a result of the validating the subject business and the validating the subject person.

Further objects, features and advantages of the present disclosure will be understood by reference to the following drawings and detailed description.

### BRIEF DESCRIPTION OF THE DRAWINGS

FIGS. 1 and 2 are schematic block diagrams of an integrated automated business and individual risk management and validation system of the present disclosure;

FIG. 3 is a schematic block diagram overview of an integrated automated business and individual risk management and validation system of the present disclosure having a risk investigation workflow portal;

FIG. 4 is a logic diagram of the enterprise risk broker process flow according to the present disclosure for a new user registration and validation process used by the present disclosure; and

FIG. 5 is a logic diagram of the enterprise risk broker process flow of FIG. 4, wherein the various decision and/or process steps are aligned with the various service, engines and databases which perform such steps.

FIG. 6 is a block diagram of a system for employment of the techniques described herein.

### DESCRIPTION OF THE INVENTION

The present disclosure pertains to a solution for the creation of registration seal, and the updating of business data via a customer either directly or via a call center or investigation function which enables users to deploy a registration seal indicating that the user has been registered or listed with a reputable credit agency. These seals create and instill a trusted digital relationship between the credit agency, its customers, and their clients. The seal imparts confidence and credibility with these clients and helps to differentiate the customer from their competition. They legitimize the company in a business environment that demands increased scrutiny by the consumer. The business data can be from standard credit data depositories or from a user or customer's own internal business, credit or financial database.

The system includes a unique automated and reusable validation process in support of the issuance of the registration seal and the updating of business data via a customer either directly or via a call center or investigation function. This includes the following: (1) individual identity validation; (2) individual/business association validation; and (3) business status validation. These services will be utilized to provide validation in real-time during a product ordering process, as well as the ongoing user and business status validations. The products could be, for example, a loan, a grant, etc., or products of any kind. In addition, the present disclosure provide a set of pre-established or customized business rules that: (a) when the rules are satisfied, utilization of the registration seal, the updating of business data via a customer either directly or via a call center or investigation function, or product purchase is permitted, or (b) when the rules have not been met, the registration seal is revoked, updating of business data via a customer either directly or via a call center or investigation function, or product purchase is rejected.

Examples of business risk identification and/or validations are as follows:
1. Legal and Financial risks e.g. if the organization:
   a. Is credit active
   b. Is out of business
   c. Is at high risk
   d. Has filed for bankruptcy (e.g., under U.S. Code, Title 11, Chapter 7)
   e. Is linked or doing business with other high risk marked organizations
   f. Has a stop distribution notice been issued
   g. Is a public company
2. Criminal or unlawful activities related risks, for example, is entity blacklisted on a Government Control List

Examples of principal or individual validations are as follows:
Verifying the validity of the principal information provided as authentic or genuine
Authenticating the principal online through use of demographic and geographic data in knowledge based identity challenge questions to identify a principal
Validation of the principal's professional license
Is principal blacklisted in a Government Control List
Validation of the principal associated with the business at a particular role or title
Validation that a principal (individual) or other business decision maker is associated with a particular company

An example of an automated and reusable validation process to apply registration seals is set forth in US Patent Publication No. 2009/0100505, filed on Oct. 16, 2007, which is incorporated herein in its entirety. A seal is an online trust building logo/certificate that combines a unique and secure technology with commercial information and business insight providing the confidence with a degree of certainty to conduct domestic and global commerce by which buyers can be confident that the vendors are legitimate and vendors can assure to their potential customers that they can be trusted.

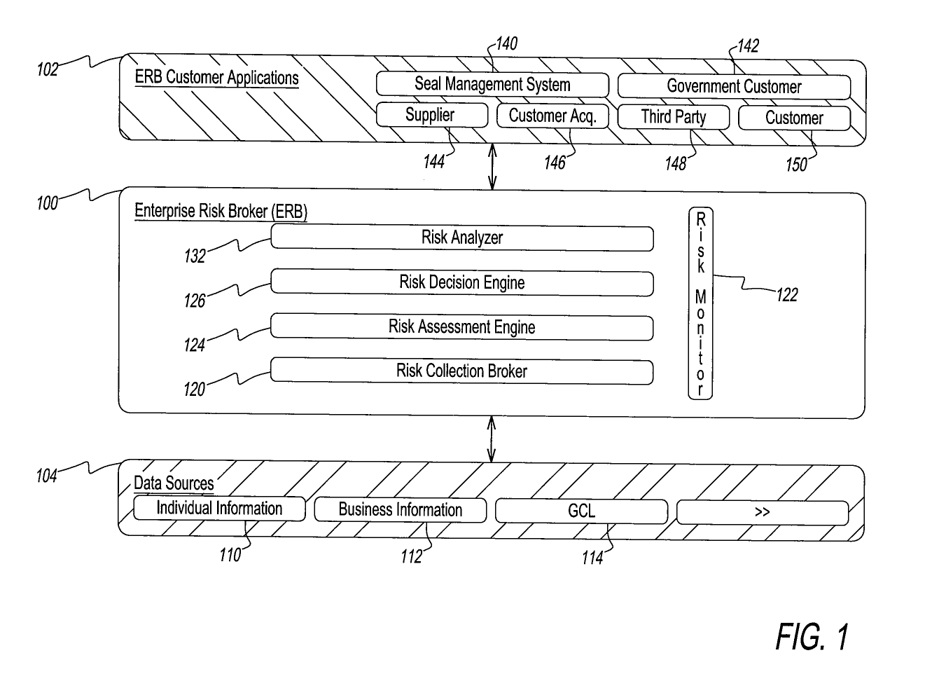

For example, assume that Company A wishes to be certified as a trusted business. A representative of Company A applies to a certifying authority, e.g., Dun & Bradstreet, via the system described herein, i.e., the ERB system, for the certification. The ERB system validates Company's A business status, validates the identity of the representative, and also validates that the representative is authorized to act on behalf of Company A. If all of these validations are favorable, the ERB system will allow the certifying authority to issue a seal to Company A. Thereafter, when a customer of Company A visits a home page of Company A's website, a seal management system 140 (see FIG. 1) will display an image of the seal on the home page, thus communicating to the customer that Company A has been certified.

Periodically, the ERB system performs an automated review of the certification. The review includes a reassessment of the validations that were performed during the initial certification process. If the review results in an unfavorable finding with regard to one or more of the validations, the certification will be revoked, and as such, the seal will not be displayed on Company A′s website.

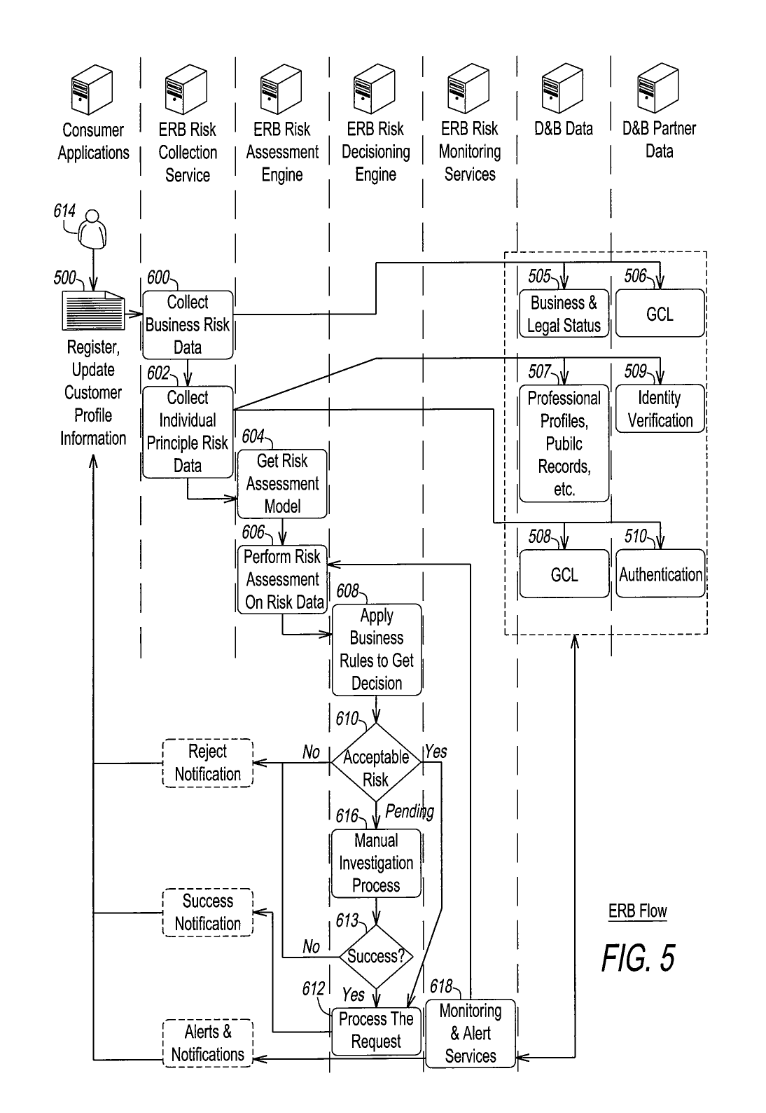

FIG. 5 is a logic diagram of the enterprise risk broker process flow according to the present disclosure for a new user registration and validation process used by the present disclosure wherein business and individual risk data is processed separately. The process starts by a request from a user 614 for registering to update customer profile information 500. The system collects business risk data 600 and then follows with collecting principal risk data 602. Thereafter, the system selects a risk assessment model 604 and then performs an assessment on the risk data 606. Once the risk assessment has been completed business rules are applied to get a decision 608 and then a determination regarding whether or not the risk is acceptable 610. If the risk is acceptable, then proceed to process the request 612. If the risk is not acceptable, then alert or notify the user 614. If automatic risk assessment is not possible, then undertake a manual investigation process 616. If the manual investigation is successful 613, then process the request 612. If not successful, then notify or alert user 614. The monitoring and alert service 618 communicates and updates databases 505, 506, 507, 508, 509 and 510, risk data 606, and user 614.

Examples of Business Rules which are Used to Allow use of the Seal
1. Business should not be associated with financial and/or legal risks such as High Risk, Out of Business, etc.
2. Business should not have stop distribution notice issued against it.
3. Business should not have filed for bankruptcy.
4. Business should not be marked as a suspected terrorist organization; or linked to any of the terrorist organizations; or blacklisted on a Government Control List for any kind of criminal or unlawful activities or under investigation.
5. Individual or the authorized representative should be associated with the business.
6. Individual identity verification should be under the acceptable confidence with a degree of certainty.
7. Individual should be able to answer the knowledge based online exam questions correctly with at least a minimum number of acceptable correct answers.
8. Individual should not be a suspected terrorist; or linked to any terrorists; or blacklisted on a Government Control List for any kind of criminal or unlawful activities or under investigation.

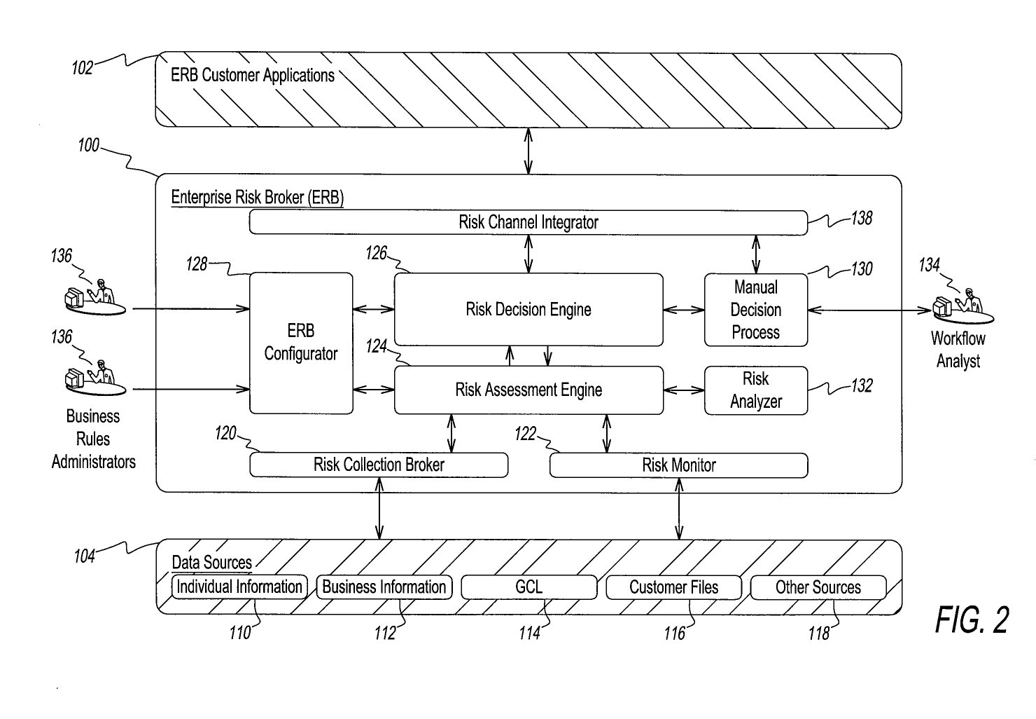

Other aspects of the present disclosure can best be described by referring to the attached figures, wherein FIGS. 1 and 2 depict the system of the present disclosure having the following major components: ERB customer applications 102, an enterprise risk broker (ERB) 100, and data sources 104. Examples of some data sources in data source 104 include, but are not limited to, a database of individual information 110, business information 112, government control list (GCL) 114, customer files 116, and other sources 118.

Individual information 110 is information about an individual, i.e., a person, from trusted datasources with a degree of certainty. Business information 112 is information about an organization or a company or a business from trusted datasources with a degree of certainty. GCL 114 is one or more Government Control Lists provided by trusted government agencies containing a list of business/organizations and individuals blacklisted for unlawful or criminal activities. Customer files 116 are files about the customers, containing their historical information. Other sources 118 includes public records, professional profiles, etc which provides the information about the customers' professional, historical profile related information.

ERB 100 is an integrated, comprehensive framework used to identify and monitor risk, easily configures risk assessment models and is a fully automated risk decision making engine. ERB 100 is capable of the following functions:
allow seamless integration with new risk sources,
includes the ability to configure risk factor models dynamically as per specific client needs,
fully automated decision making capabilities,
key risk indicator monitoring allows users to react immediately when the risk changes,
prioritizes high risk items for analyst review,
cross system integration delivers an enterprise wide view and transparency into risk exposure and strategy execution.

Risk Assessment process flow can easily be summarized into following sequence:

1. Risk Collection

2. Risk Assessment

3. Risk Decision Making

4. Risk Monitoring

Risk Collection: Key functionality of this module is to collect various Business & Principals risk data (business status, government regularities, employee associations . . . etc) from various data sources 104 such as GCL, customer data, public records, professional profiles, etc. A risk collection broker 120 collects the risk data from these data sources 104 and updates the ERB risk collection database system. Risk collection broker 120 is flexible and scalable to integrate different risk data sources with ease.

Risk Assessment: Once the risk data is collected, a risk assessment engine 124 performs risk assessment on the collected data based on the various criteria set as per the business needs. This assessment includes the validations for certification of a business for the issuance of a seal, as described above. Risk assessment status is updated and saved into the ERB risk assessment database system. Business Rules Administrators 136 configure risk models, services, and success/reject criteria for the assessment using an ERB configurator 128 as part of set-up activity. Such business rules can be customized for a particular client.

Risk Decision Making: Once the assessment is completed for all the services namely (Business status, GCL, Verification, Authentication, Business Association and so on), overall decision and scoring is made using a risk decision engine 126 based on the assessment status of various services and the rules configured. Decision could vary from success, reject and in some cases it may call for manual intervention. In such cases, manual investigation would be performed by a workflow analyst 134 using a manual decision process 130. Once they perform their analysis they would update manual decision process 130 with their decision and notify the consumer applications.

Risk Monitoring: Once the risk assessment is provided to the consumer applications, there is a probability that risk associated for the business or individual may change with time. For all those consumers who have registered for monitoring, a risk monitor 122, monitors any change in the risk data and triggers re-assessment and sends appropriate alert notification. Risk monitor 122 also performs the review of the seal certification, i.e., the reassessment of the validations that were performed during the initial seal certification process, as described above. If the review results in an unfavorable finding with regard to one or more of the validations, risk monitor 122 will issue an alert notification to seal management system 140.

Seal management system 140, as mentioned above, enables a seal to be displayed on a company's web-site. If seal management system receives an alert notification from risk monitor 122, seal management system 140 will revoke the seal.

A risk analyzer 132 provides user-friendly reporting with high-level views, risk trend analyses, and executive-level dashboards on the assessment status, risk data, risk decision and so on.

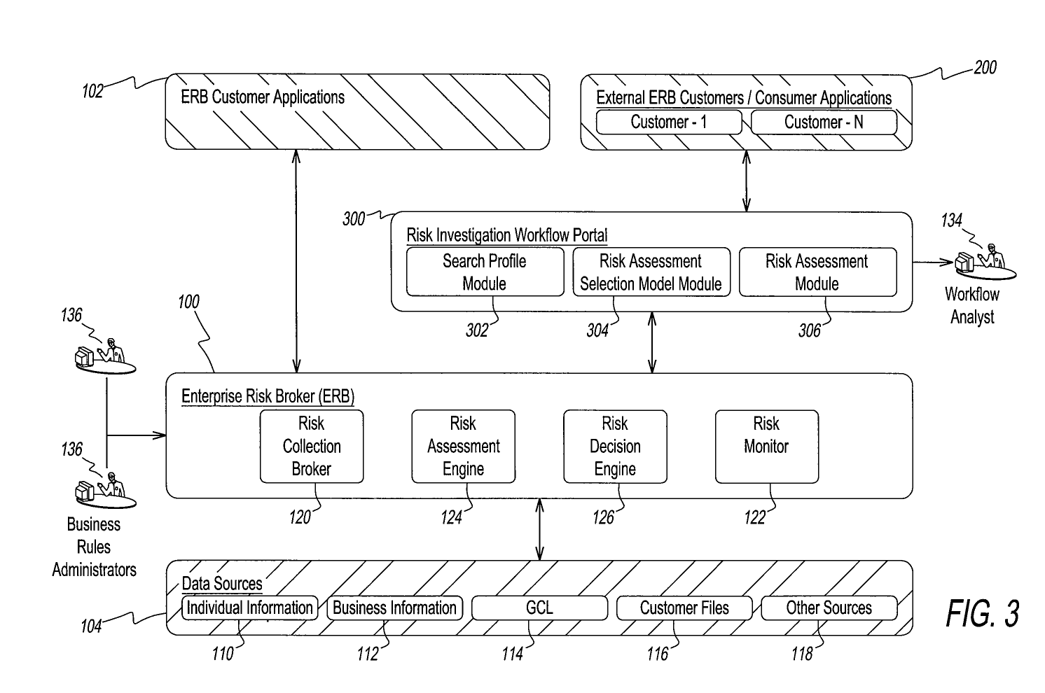

A risk investigation workflow portal 300 (see FIG. 3) can be used by internal risk investigators, customer service agents, or new account opening agents in the onboarding process. This portal provides web interface for assessing the risk.

ERB customer applications 102 includes, for example, seal management system 140, government customer application 142, a supplier application 144, a customer acquisition application 146, a third party application 148, a customer application 150, etc. A risk channel integrator 138 provides two ways for external clients or applications to interface with. Firstly ERB is exposed as a web-service which can be easily consumed real time by external applications. Secondly, for bulk validations, ERB provides a batch processing developed on a Message based Queue (MQ) mechanism. Based on their requirement, real time or batch (bulk), external application can leverage any of the interfaces provided (web-service or MQ).

FIG. 3 is another embodiment wherein a risk investigation workflow portal 300 is disposed between external ERB customers/consumer applications 200 and ERB 100 for the purpose of collecting the risk data from various sources, evaluates the risk based on risk assessment models, decisioning on the evaluated risks, continuous monitoring and alerting, and analytics and reporting. Preferably, risk investigation workflow portal 300 includes: a search profile module 302, a risk assessment selection model module 304, and a risk assessment module 306.

Search profile module 302 typically involves searching the company profile and searching the individual profiles. Risk assessment module 306 automatically performs a risk investigation via an authentication exam and automated risk decision status, as well as a manual risk investigation, if necessary.

To access the risk investigation workflow portal 300, a user will typically login to access the risk investigation system by submitting business and individual information. Thereafter, search profile module 302 allows for the searching of a business based on a corporate identification number (e.g., Data Universal Numbering System (DUNS) Number), searching a business based on name and address, and searching of individual based on individual data. A DUNS Number is a unique number for an organization or a company that can be provided for each organization or company in the world. The risk assessment selection model module 304 allows a user to select from a plurality of risk models. The optional automated risk evolution module displays the risk assessment and decision for that business or principal. If a manual risk investigation is required, then risk assessment module 306 allows the user to perform offline manual investigation and based on the analysis would update the risk assessment and decision in the system. This would further update the downstream/risk sources, allow for configuration of approval level/phases, and generate the appropriate e-mail notifications. Finally, the risk investigation workflow portal 300 should support reporting the risk information based on investigation status, auditing related information, etc.

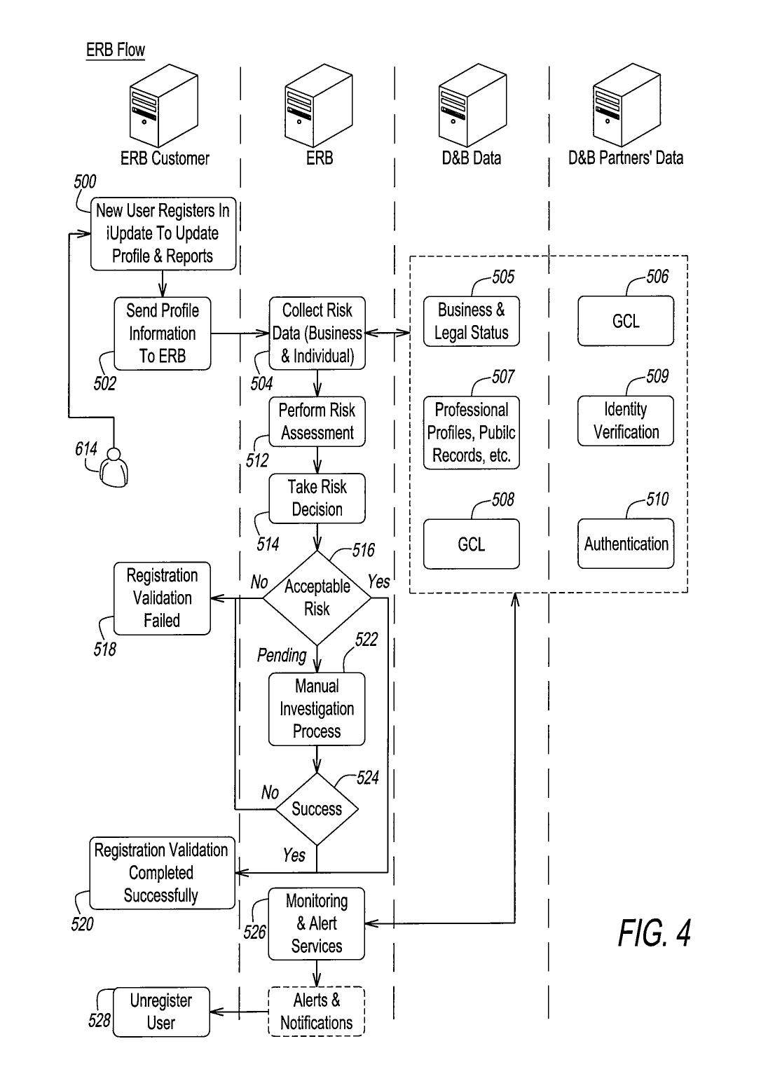

FIG. 4 is a logic diagram of the enterprise risk broker process flow according to the present disclosure for a new user registration and validation process used by the present disclosure wherein business and individual risk data is processed together. The ERB flow starts with a new user 614 registering in ERB customer application to update profile and report 500 and profile information is then sent to ERB 502. Thereafter risk data is collected for both business and individuals 504 from databases 505-510 before the risk assessment is performed 512 followed by the take risk decision 514. The system then determines if the risk is acceptable 516. If the risk is not acceptable, then the registration validation will fail 518. If the risk is acceptable, then registration validation is successfully completed 520. If risk cannot be accurately determined, then it will be held pending until a manual investigation 522 can be undertaken. If the manual investigation is successful 524, the registration validation is successfully completed 520. If the manual investigation is unsuccessful, then registration validation will fail 518. Any changes in the data stored in databases 505-510 are sent to a monitoring and alert service 526 which can result in the unregistering of user 528 if any business rules are not complied with.

Refer to FIG. 5 for Seal/Certification order flow, wherein the following systems are involved in the order flow namely:
1. ERB: Provides Risk Assessment
2. ERB Customer Portal: Provides a portal for a company to buy a Seal/Certificate and performs payment processing.
3. Seal Management System: Enables the seal to be displayed on the company's web-site.
4. Business Process Management System (BPMS) bases process flow: Provides work flow capabilities

### Order Process Flow:

1. Ordering process starts when a representative of a company logs into an ERB customer portal main menu, browses to a Seal/Certificate product-specific page and applies for a seal.
2. Once the representative selects the Buy option, the representative is requested to register with D&B. Once the representative provides the registration information, namely the company and individual details, D&B performs risk assessment by using ERB.
3. Business validation is performed to find the risk associated with the company. Such risks include being out of business, Bankruptcy, high risk or enlistment in any Government Control List. If the validation of the company is favorable, individual to business validations are performed to ensure that the representative is associated with the business. Then, individual validation is performed to ensure that the representative is the one who he/she claims to be and is not enlisted in any Government Control List.
4. If the assessment fails, the representative is informed that the order for the seal cannot be completed.
5. If the assessment is successful, ordering process for the seal is continued. The company is charged, the seal is enabled, and the representative is notified about seal enablement.

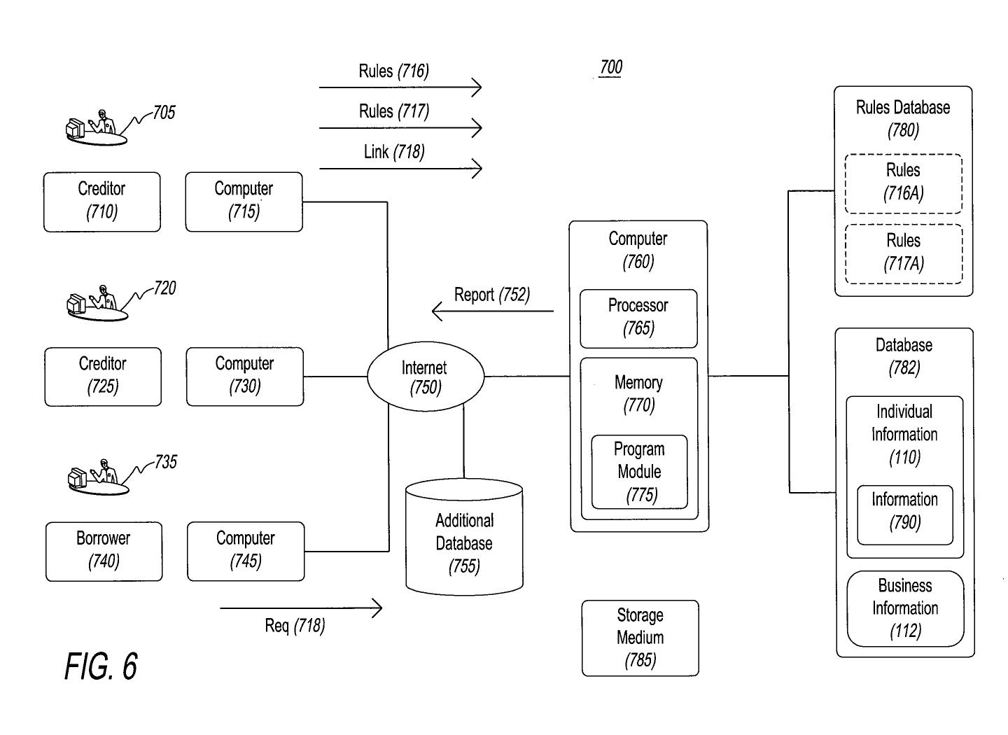

FIG. 6 is a block diagram of a system 700 for employment of the techniques described herein. System 700 includes computers 715, 730, 745 and 760 communicatively coupled to a data communication network, e.g., the Internet 750.

Computer 760 includes a processor 765, and a memory 770. Although computer 760 is represented herein as a standalone device, it is not limited to such, but instead can be coupled to other devices (not shown) in a distributed processing system.

Processor 765 is an electronic device configured of logic circuitry that responds to and executes instructions.

Memory 770 is a computer-readable storage medium encoded with a computer program. In this regard, memory 770 stores data and instructions that are readable and executable by processor 765 for controlling the operation of processor 765. Memory 770 may be implemented in a random access memory (RAM), a hard drive, a read only memory (ROM), or a combination thereof. One of the components of memory 770 is a program module 775.

Program module 775 contains instructions for controlling processor 765 to execute the methods described herein. Although the present document may describe actions being performed by computer 760, such actions are more specifically being performed by processor 765 pursuant to instructions in program module 775.

The term “module” is used herein to denote a functional operation that may be embodied either as a stand-alone component or as an integrated configuration of a plurality of sub-ordinate components. Thus, program module 775 may be implemented as a single module or as a plurality of modules that operate in cooperation with one another. Moreover, although program module 775 is described herein as being installed in memory 770, and therefore being implemented in software, it could be implemented in any of hardware (e.g., electronic circuitry), firmware, software, or a combination thereof

While program module 775 is indicated as being already loaded into memory 770, it may be configured on a storage medium 785 for subsequent loading into memory 770. Storage medium 785 is a computer-readable storage medium and can be any conventional storage medium that stores program module 775 thereon in tangible form. Examples of storage medium 785 include a compact disk, a magnetic tape, a read only memory, an optical storage media, a hard drive or a memory unit consisting of multiple parallel hard drives, and a universal serial bus (USB) flash drive. Alternatively, storage medium 785 can be a random access memory, or other type of electronic storage, located on a remote storage system and coupled to computer 760 via the Internet 750.

Computer 760 is also communicatively coupled to a rules database 780 and a database 782. Database 782 is an exemplary representation of data sources 104, and therefore contains, for example, individual information 110 and business information 112. Although individual information 110 and business information 112 are shown as being components of database 782, each of individual information 110 and business information 112 can reside in its own database, e.g., an individual information database and a business information database, respectively. Generally, database 782 may be configured as a plurality of databases that collectively represent data sources 104.

Computer 715 is being used by a user 705 at a creditor 710. Computer 730 is being used by a user 720 at a creditor 725. Computer 745 is being used by a user 735 at a borrower 740. Each of users 705, 720 and 735 is a person. Each of creditor 710, creditor 725 and borrower 740 is a business entity. Computers 715, 730 and 745 can be any conventional computer devices configured with user interfaces for users 705, 720 and 735, respectively, to communicate with computer 760, by way of electronic communication, via the Internet 750.

Computer 760 communicates with each of rules database 780 and database 782 by way of electronic communication. Although rules database 780 and database 782 are shown as being directly coupled to computer 760, thus suggesting that they are located in close proximity to computer 760, they could be located at a remote location and coupled to computer 760 via the Internet 750.

Below, there is presented an example of an employment of computer 760.

User 705, acting on behalf of creditor 710, specifies rules for validating a business, i.e., rules 716, and rules for validating a person, i.e., rules 717. Processor 765 receives rules 716 and 717, and stores them to rules database 780 as rules 716A and 717A, respectively.

Thereafter, processor 765 receives a request 746 to validate borrower 740 and user 735. Request 746 may be a result of, for example, an order being placed by user 735 to purchase goods for borrower 740, on credit, from creditor 710. Request 746 need not necessarily be transmitted directly from computer 745, but instead could be transmitted by computer 715 or some other device (not shown) as a result of user 735 engaging in a transaction with creditor 710.

Processor 765 accesses rules database 780 to obtain rules 716A and 717A.

Processor 765 validates borrower 740 in accordance with rules 716A based on business information 112. Such validation may include, for example, confirming that borrower 740 is a viable business, i.e., not bankrupt, and is not listed on a government control list.

Processor 765 validates user 735 in accordance with rules 717A based on individual information 110. Such validation may include, for example, confirming that user 735 is whom he or she purports to be, and is authorized to represent borrower 740.

If necessary, the validation of user 735 may involve a dialog between user 735 and computer 760. For example, processor 765 obtains, from individual information 110, information 790, which is information about user 735, i.e., the real person whom user 735 purports to be, that was provided by a source other than user 735. For example, information 790 may be a former address of user 735 provided by a postal address database (not shown). Processor 765 then presents to user 735, by way of communication through computer 745, a question, e.g., “What is your former address?”, to be answered by user 735, based on information 790.

Processor 765 outputs a report 752 that indicates a result of the validations of borrower 740 and user 735. In this regard, processor 765 may transmit report 752 to either or both of computer 715 and computer 745. Additionally, creditors 710 and 725, and borrower 740 can view a seal on computers 715, 730 and 745, respectively, which can increases trust between creditor and borrower and their businesses. The seal is enabled by seal management system 140.

Another feature of program module 775 is that it handles a situation where user 705 wishes for the validation of either or both of user 735 and borrower 740 to be based on information in an additional database 755. Thus, additional database 755 can serve as an alternative or a supplement to database 782.

Additional database 755 may be managed by creditor 710 or a third party. For example, assume that additional database 755 is a public records database. User 705 may specify that the validation of user 735 may require user 735 to identify a company to whom user 735 is linked in the public records database. Similarly, assume that additional database 755 contains information about sales and earnings of business. User 705 may specify that the validation of borrower 740 may require that earnings be greater than or equal to a certain percentage of sales. Accordingly, user 705 sends, and processor 765 receives, a link to an Internet address, e.g., a uniform resource locator, through which additional database 755 is accessible, and for the validation, processor 765 accesses additional database 755 through the Internet address.

Although the operation of processor 765 is described above as validating both user 735 and borrower 740, together, program module 775 includes a capability for processor 765 to validate user 735 and borrower 740 independently of one another. In other words, in response to a request (not shown), processor 765 may validate user 735 as an individual, independent of borrower 740, e.g., to authenticate user 735′s identity, or may validate borrower 740 independent of user 735, e.g., to confirm that borrower 740 is not bankrupt.

User 720, on behalf of creditor 725, may similarly perform all of the operations described above for user 705. Accordingly, if user 735 engages in a transaction with creditor 725, processor 765 will validate user 735 and borrower 740 in accordance with rules specified by user 720.

Thus, processor 765 executes a method that includes:
receiving by way of an electronic communication, with reference to a first entity, rules for validating a business and rules for validating a person;
storing to a rules database by way of an electronic communication, the rules for validating a business and the rules for validating a person;
receiving by way of an electronic communication, a request to validate, for the first entity, a subject business and a subject person;
accessing the rules database by way of an electronic communication, to obtain the rules for validating a business and the rules for validating a person;
validating the subject business in accordance with the rules for validating a business, based on information in a business information database;
validating the subject person in accordance with the rules for validating a person, based on information in an individual information database; and
outputting by way of an electronic communication, a report that indicates a result of the validating the subject business and the validating the subject person.

Additionally, wherein the entity is a first entity, the rules for validating a business are first rules for validating a business, and the rules for validating a person are first rules for validating a person, the method further includes:
receiving by way of an electronic communication, with reference to a second entity, second rules for validating a business and second rules for validating a person;
storing to the rules database by way of an electronic communication, the second rules for validating a business and the second rules for validating a person;
receiving by way of an electronic communication, a request to validate, for the second entity, the subject business and the subject person;
accessing the rules database by way of an electronic communication, to obtain the second rules for validating a business and the second rules for validating a person;
validating the subject business in accordance with the second rules for validating a business, based on information in the business information database;
validating the subject person in accordance with the second rules for validating a person, based on information in the individual information database; and
outputting by way of an electronic communication, a report that indicates a result of (a) the validating the subject business in accordance with the second rules for validating a business, and (b) the validating the subject person in accordance with the second rules for validating a person.

Thus, in system 700 each of creditor 710 and creditor 725, through actions of their respective users 705 and 720, can specify rules and information for the validation of a business and validation of an individual. The rules specified by creditor 710 can be different from those specified by creditor 725, and the rules for validating a business can be different from the rules for validating an individual. This flexibility allows system 700 to facilitate the unique requirements of each of creditor 710 and creditor 725, such as in a situation where creditor 710 is an automobile retailer, creditor 725 is a government agency, and borrower 740 is a small business seeking to (a) obtain financing for a purchase of an automobile from creditor 710, and (b) obtain a small business loan from creditor 725.

Although system 700 is shown as having two creditors 710 and 725, and one borrower 740, computer 760 is capable of servicing any desired number of creditors and borrowers. Moreover, the entities that utilize system 700 need not necessarily be creditors and borrowers, but instead, can have any business relationship, e.g., potential business partners.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method comprising:
receiving by way of an electronic communication, with reference to a first entity, rules for validating a business and rules for validating a person;
storing to a rules database by way of an electronic communication, said rules for validating a business and said rules for validating a person;
receiving by way of an electronic communication, a request to validate, for said first entity, a subject business and a subject person;
accessing said rules database by way of an electronic communication, to obtain said rules for validating a business and said rules for validating a person;
validating said subject business in accordance with said rules for validating a business, based on information in a business information database;
validating said subject person in accordance with said rules for validating a person, based on information in an individual information database; and
outputting by way of an electronic communication, a report that indicates a result of said validating said subject business and said validating said subject person.

2. The method of claim 1,
wherein said entity is a first entity, said rules for validating a business are first rules for validating a business, and said rules for validating a person are first rules for validating a person, and
wherein said method further comprises:
receiving by way of an electronic communication, with reference to a second entity, second rules for validating a business and second rules for validating a person;
storing to said rules database by way of an electronic communication, said second rules for validating a business and said second rules for validating a person;
receiving by way of an electronic communication, a request to validate, for said second entity, said subject business and said subject person;
accessing said rules database by way of an electronic communication, to obtain said second rules for validating a business and said second rules for validating a person;
validating said subject business in accordance with said second rules for validating a business, based on information in said business information database;
validating said subject person in accordance with said second rules for validating a person, based on information in said individual information database; and
outputting by way of an electronic communication, a report that indicates a result of (a) said validating said subject business in accordance with said second rules for validating a business, and (b) said validating said subject person in accordance with said second rules for validating a person.

3. The method of claim 1, further comprising:
receiving by way of an electronic communication, a link to an Internet address through which said business information database is accessible,
wherein said validating said subject business comprises accessing said business information database by way of an electronic communication, through said Internet address.

4. The method of claim 1, further comprising:
receiving by way of an electronic communication, a link to an Internet address through which said individual information database is accessible,
wherein said validating said subject person comprises accessing said individual information database by way of an electronic communication, through said Internet address.

5. The method of claim 1, wherein said validating said subject person comprises:
obtaining from said individual information database by way of an electronic communication, information about said subject person that was provided by a source other than said subject person; and
presenting by way of an electronic communication, a question to be answered by said subject person, based on said information about said subject person that was provided by said source.

6. A system comprising:
a processor; and
a memory that contains instructions that are readable by said processor, and that when read by said processor, cause said processor to perform actions of:
receiving by way of an electronic communication, with reference to a first entity, rules for validating a business and rules for validating a person;
storing to a rules database by way of an electronic communication, said rules for validating a business and said rules for validating a person;
receiving by way of an electronic communication, a request to validate, for said first entity, a subject business and a subject person;
accessing said rules database by way of an electronic communication, to obtain said rules for validating a business and said rules for validating a person;
validating said subject business in accordance with said rules for validating a business, based on information in a business information database;
validating said subject person in accordance with said rules for validating a person, based on information in an individual information database; and
outputting by way of an electronic communication, a report that indicates a result of said validating said subject business and said validating said subject person.

7. The system of claim 6,
wherein said entity is a first entity, said rules for validating a business are first rules for validating a business, and said rules for validating a person are first rules for validating a person, and
wherein said instructions cause said processor to perform further actions of:
receiving by way of an electronic communication, with reference to a second entity, second rules for validating a business and second rules for validating a person;
storing to said rules database by way of an electronic communication, said second rules for validating a business and said second rules for validating a person;
receiving by way of an electronic communication, a request to validate, for said second entity, said subject business and said subject person;
accessing said rules database by way of an electronic communication, to obtain said second rules for validating a business and said second rules for validating a person;
validating said subject business in accordance with said second rules for validating a business, based on information in said business information database;
validating said subject person in accordance with said second rules for validating a person, based on information in said individual information database; and
outputting by way of an electronic communication, a report that indicates a result of (a) said validating said subject business in accordance with said second rules for validating a business, and (b) said validating said subject person in accordance with said second rules for validating a person.

8. The system of claim 6, wherein said instructions cause said processor to perform a further action of:
receiving by way of an electronic communication, a link to an Internet address through which said business information database is accessible,
wherein said validating said subject business comprises accessing said business information database by way of an electronic communication, through said Internet address.

9. The system of claim 6, wherein said instructions cause said processor to perform a further action of:
receiving by way of an electronic communication, a link to an Internet address through which said individual information database is accessible,
wherein said validating said subject person comprises accessing said individual information database by way of an electronic communication, through said Internet address.

10. The system of claim 6, wherein said validating said subject person comprises:
obtaining from said individual information database by way of an electronic communication, information about said subject person that was provided by a source other than said subject person; and
presenting by way of an electronic communication, a question to be answered by said subject person, based on said information about said subject person that was provided by said source.

11. A storage medium that is non-transitory and computer readable, comprising instructions that are readable by a processor, and that when read by said processor, cause said processor to perform actions of:
receiving by way of an electronic communication, with reference to a first entity, rules for validating a business and rules for validating a person;
storing to a rules database by way of an electronic communication, said rules for validating a business and said rules for validating a person;
receiving by way of an electronic communication, a request to validate, for said first entity, a subject business and a subject person;
accessing said rules database by way of an electronic communication, to obtain said rules for validating a business and said rules for validating a person;
validating said subject business in accordance with said rules for validating a business, based on information in a business information database;
validating said subject person in accordance with said rules for validating a person, based on information in an individual information database; and
outputting by way of an electronic communication, a report that indicates a result of said validating said subject business and said validating said subject person.

12. The storage medium of claim 11,
wherein said entity is a first entity, said rules for validating a business are first rules for validating a business, and said rules for validating a person are first rules for validating a person, and
wherein said method further comprises:
receiving by way of an electronic communication, with reference to a second entity, second rules for validating a business and second rules for validating a person;
storing to said rules database by way of an electronic communication, said second rules for validating a business and said second rules for validating a person;
receiving by way of an electronic communication, a request to validate, for said second entity, said subject business and said subject person;
accessing said rules database by way of an electronic communication, to obtain said second rules for validating a business and said second rules for validating a person;
validating said subject business in accordance with said second rules for validating a business, based on information in said business information database;
validating said subject person in accordance with said second rules for validating a person, based on information in said individual information database; and
outputting by way of an electronic communication, a report that indicates a result of (a) said validating said subject business in accordance with said second rules for validating a business, and (b) said validating said subject person in accordance with said second rules for validating a person.

13. The storage medium of claim 11, wherein said instructions cause said processor to perform a further action of:
receiving by way of an electronic communication, a link to an Internet address through which said business information database is accessible,
wherein said validating said subject business comprises accessing said business information database by way of an electronic communication, through said Internet address.

14. The storage medium of claim 11, wherein said instructions cause said processor to perform a further action of:
receiving by way of an electronic communication, a link to an Internet address through which said individual information database is accessible,
wherein said validating said subject person comprises accessing said individual information database by way of an electronic communication, through said Internet address.

15. The storage medium of claim 11, wherein said validating said subject person comprises:
obtaining from said individual information database by way of an electronic communication, information about said subject person that was provided by a source other than said subject person; and
presenting by way of an electronic communication, a question to be answered by said subject person, based on said information about said subject person that was provided by said source.
